(19) United States
(12) Patent Application Publication
(10) Pub. No.: US 2007/0037892 A1
(43) Pub. Date: Feb. 15, 2007

(54) Aqueous slurry containing metallate-modified silica particles

(76) Inventor: Irina Belov, Zionsville, IN (US)

Correspondence Address: PRAXAIR, INC.;LAW DEPARTMENT - M1 557, 39 Old Ridgebury Road, Danbury, CT, 06810-5113, US

(21) Appl. No.: 10/935,420

(22) Filed: Sep. 8, 2004

(51) Int. Cl. B01F 3/12; C01B 33/26

(52) U.S. Cl. 516/79; 51/308

(57) ABSTRACT

Provided is a novel aqueous slurry composition for polishing/planarization of a substrate. The composition includes silicon dioxide abrasive particles wherein the abrasive particles are anionically modified/doped with metallate anions selected from the group consisting of aluminate, stannate, zincate and plumbate, thereby providing a high negative surface charge to the abrasive particles and enhances the stability of the slurry composition.

### BACKGROUND OF THE INVENTION

1. Field of the Invention

The present invention relates to aqueous slurry compositions for the Chemical Mechanical Polishing/Planarization (“CMP”) of substrates. The slurries of the present invention are useful for polishing metal layers, such as copper and copper alloys, which are utilized in the process of metal interconnect formation on IC devices. Particularly, the slurry of the present invention includes an anionically modified silica abrasive component, which provides stability to the aqueous slurry. The slurry compositions of the present invention, are further useful for other polishing/planarization applications employing acidic slurries, such as tungsten interconnect and shallow trench isolation CMP, polishing of hard drive disks, and fiber optic connectors.

2. Description of Related Art

Global planarization of topographic features is commonly utilized in the manufacture of high performance ultra-large scale (ULSI) devices. Integrated circuits (IC) with smaller device dimensions, increasing packaging density and multiple metal insulating wiring levels impose stringent planarity demands on the IC manufacturing process. Non-planarity deleteriously impacts the device yield and performance.

Dual-damascene copper patterning is the technology of choice for multilevel interconnect formation of advanced generation IC devices. In dual-damascene processing, images of both via holes and trenches are etched in a dielectric layer followed by deposition of a thin barrier layer to prevent copper diffusion into dielectric. In the state-of-the-art, the diffusion barrier is a composite layer of tantalum and tantalum nitride. A thin seed layer of copper is deposited on the barrier layer and is followed by deposition of the bulk copper layer. CMP has been established as a key process step to remove the copper overburden from the damascene structures and to meet planarization requirements.

The two major topography related concerns in the polishing of copper damascene structures is dishing of the copper lines and erosion of the field dielectric. To overcome these concerns, a two-step copper CMP process has been adopted. The first step is to polish and remove the bulk copper overburden; and the second is to polish and remove the tantalum nitride/tantalum barrier while planarizing the surface for further processing. The first step is carried out in a manner where the process stops upon reaching the barrier layer. The second step can be performed so as to utilize a selective slurry to remove the residual copper and the barrier, yet stopping on the dielectric layer, or alternatively to utilize a non-selective slurry which removes copper, barrier and dielectric at similar removal rates.

Another important requirement in copper CMP processes is that the wafer surface following the CMP process must be free of defects such as pits, microscratches and particles. CMP processing faces an increasing demand to reduce defects without a negative impact on production throughput. The fewer defect requirement becomes more difficult to meet with integration of low-k dielectric materials which have poor mechanical strength.

Slurries typically developed and utilized for copper CMP generally contain the following components: (a) an oxidant to oxidize the copper layer and form copper oxides, hydroxides and ions; (b) a chelating agent to react with the oxidized layer and assist in the removal of polishing debris from the reaction zone; (c) a corrosion inhibitor to eliminate unwanted isotropic etch through the creation of a protective layer on copper film surface and further preventing recessed areas from chemical interaction with the slurry; and (d) abrasive particles.

Steigerwald et al's “Surface Layer Formation During the Chemical Mechanical Polishing of Copper Thin Films” Mat. Res. Soc. Symp.Proc., v. 337, pp. 133-38, 1994, discloses principal chemical processes during copper CMP as surface layer formation, dissolution of mechanically abraded copper through the use of a complexing agent or an oxidizing acid and chemical acceleration of copper removal by oxidizing agents. Caprio et al “Initial Study on Copper CMP Slurry Chemistries” Thin Solid Films, v. 266, pp. 238-44, 1995, proposed two approaches to slurry formulations in order to protect the recessed areas on the patterned wafer from undesired isotropic etch and simultaneously provide adequate planarization. The approaches include the application of passivation chemistry with neutral or basic pH or dissolution chemistry with corrosion inhibitors and acidic pH. Often the slurry for bulk copper removal is acidic, due to the high removal rate (RR) and high removal selectivity of copper as opposed to the tantalum/tantalum nitride barriers and silicon dioxide field dielectrics. In accordance with currently accepted CMP models and mechanisms such as those of Hariharaputhiran et al, Hydroxyl Radical Formation in H₂O₂—Amino Acid Mixtures and Chemical Mechanical Polishing of Copper” J. Electrochem. Soc., v. 147. pp 3820-826, 2000, and Brusic et al, “Electrochemical Approach to Au and Cu CMP Process Development” Electrochem. Soc. Proc. v. 96-22, pp 176-85, abrasive particles of slurry perform several functions: (a) provide mechanical action of abrading a surface layer formed on the polished film by slurry liquid phase and exposing new material for chemical interaction; (b) deliver chemistry to a wafer surface and assist in removal of polishing debris; and (c) serve as a Theological modifier.

To accomplish the aforementioned functions and to achieve a smooth post-CMP surface with a low number of defects it is necessary that the abrasive particles have an appropriate hardness, size and morphology. The particle type, size and distribution show a strong correlation to the type of scratches and to the scratch count on the wafer surface. Further, it is paramount that the particles form a stable dispersion in the slurry. Particle growth and formation of particle agglomerates result in an increased level of defects on the polished surface.

Alumina and silica are the abrasive particles most often employed in the CMP processes. Alumina abrasive particles are often utilized for metal CMP since they demonstrate higher removal rates and have lower chemical reactivity towards dielectric materials. Accordingly, they have a higher selectivity than silica particles. Kaufman et al in U.S. Pat. Nos. 5,954,997 and 6,063,306 discloses slurries including alumina as abrasive, a complexing agent, an oxidizer, and a film forming agent. The slurry is capable of polishing copper slurries with high removal rate (up to 8000 Å/min) and selectivity toward the barrier layer.

However, alumina-based slurries have significant drawbacks. Al₂O₃ particles are agglomerates of microcrystals with high hardness, they are difficult to disperse and therefore, prone to form defects on the polished surface. Alumina particles have a high positive surface charge at acidic pH (isoelectric point of Al₂0₃ is at pH of about 9), which causes increased electrostatic interaction with a metal layer and results in difficulties of post-CMP wafer cleaning.

Silica abrasive particles have lower hardness and generally form a more stable dispersion than alumina particles. In addition, silicon dioxide (SiO₂) particles are negatively charged in acidic slurries which is advantageous for post-CMP cleaning procedures. The two types of silica used in CMP slurries are colloidal and fumed particles. Particles of fumed silica, as produced, inherently agglomerate. Therefore, as discussed in Zwicker et al “Characterization of Oxide-CMP Slurries with Fumed Silica Abrasive Particles Modified by Wet-Jet Milling”, Proc. CMP-MIC Conf., pp. 216-23, 2004, the fumed silica require further treatment and processing before usage.

Colloidal silica-based slurries that contain amorphous, nonagglomerated SiO₂ particles with a spherical morphology, lead to smooth polished surfaces with fewer defects as opposed to fumed silica-based and alumina-based slurries. On the other hand, the drawback of colloidal silica-based slurries is the reduced removal rate in comparison to fumed SiO₂ and Al₂O₃ containing slurries. As described in Hirabayashi et al “Chemical Mechanical Polishing of Copper Using a Slurry Composed of Glycine and Hydrogen Peroxide” Proc. CMP-MIC Cong. Pp. 119-23, 1996 and U.S. Pat. No. 5,575,885 CMP of copper performed with a slurry containing glycine as a complexing agent, hydrogen peroxide as an oxidizer and silica abrasive, with or without a corrosion inhibitor, results in a low static etch rate and number of defects. The removal rate reported, however, was not high enough for efficient bulk copper removal.

In order to increase the removal rate of colloidal silica-based slurries they have to be modified so as to render them chemically aggressive (e.g., lower pH, higher concentration of removal accelerators, corrosion inhibitors, etc.). Unfortunately, decreasing the pH leads to a decrease in surface charge and hence destabilization of colloidal silica. As described in Iler “The Chemistry of Silica” J. Wiley & Sons, pp. 186-89, 355-82, 407-15 (1979) and Allen et al “Stability of Colloidal Silica III. Effect of Hydrolyzable Cations” J. Colloidal Interface Sci., v. 35, pp 66-75 (1971) pH has a dominant effect upon silica sol stability and the gelling rate of silica sols increases near and below a pH of 3. Likewise, an increase in ionic strength of a slurry associated with the increased content of removal accelerating compounds causes destabilization due to the reduction in the overall net repulsion effect of the colloidal particles.

The surface charge of colloidal silica particles is greatly influenced by the surface modification of silica; the surface can be modified by attachment of different atoms or groups. Alexander et al in U.S. Pat. No 3,007,878 discloses the reversal of the negative charge of nonmodified silica particles into a positive charge by polyvalent metal coatings such as aluminum, chromium, gallium, titanium and zirconium. For example, if the silica surface is covered with a layer of alumina, even one as thin as a monolayer, it will behave as an alumina particle, bearing a positive charge.

Puppe et al in U.S. Patent Application No. 2003/0157804 discloses a CMP slurry containing cationically modified silica. A positive charge on the silica particles had been produced by reaction of non-modified sol with soluble compounds of trivalent or tetravalent metals. The stability study of these positive sols demonstrated that at a low pH certain anions show a destabilizing effect.

Ronay in U.S. Pat. No. 5,876,490 discloses a slurry for polishing microelectronic substrates, particularly copper interconnect structures which include polyelectrolyte-coated silica particles as a portion of abrasive particles. Polyions such as polyacrylic acid, polymaleic acid, etc. are strongly attached to the particle surface and the polymer lies flat on the particle surface until a monolayer coverage is achieved. This results in a reduced polishing rate in recesses while higher removal rate on elevated portions is maintained by non-coated part of silica particles.

Helling et al in U.S. Pat. No. 6,656,241 discloses a slurry which includes silica abrasive particles surface-modified with organosilanes. The slurry claimed provides a copper to tantalum selectivity due to it non-Prestonian behavior toward the tantalum barrier material. The major drawback of the disclosed slurries is that the method of preparing surface modified silica particles requires several steps. The processes are time consuming operations which include silica precipitate filtration, washing of filter cake followed by re-dispersion. The method results in the formation of aggregates of primary particles. Therefore, additional particle size reduction operations still remain to be performed.

To overcome the disadvantages associated with the art related slurries and to meet the polishing/planarization requirements a slurry composition, wherein the abrasive particles are anionically modified/doped is provided.

One object of the invention is to provide a slurry composition which is particularly useful in the processing of copper interconnect damascene structure.

Another object of the invention to provide a stable slurry composition, wherein the anionic modification of the abrasive silica particles leads to increased stability of the particles in an acidic environment.

A further object of the invention to provide a slurry composition with low static etch rate of copper film and high selectivity toward tantalum nitride/tantalum barrier material removal.

It is yet a further object of the invention, to provide high rates of copper removal; similar to those provided by alumina-based slurries while preserving advantages of using colloidal silica abrasive (i.e., low roughness and reduced defects in the polished surface).

Other objects and advantages of the invention will become apparent to one skilled in the art on a review of the specification, figures and claims appended hereto.

### SUMMARY OF THE INVENTION

The foregoing objectives are met by the aqueous slurry composition of the present invention.

According to a first aspect of the invention, an aqueous slurry composition for polishing/planarization of a substrate is provided. The composition includes silicon dioxide abrasive particles wherein the abrasive particles are anionically modified/doped with metallate anions selected from the group consisting of aluminate, stannate, zincate and plumbate, thereby providing a high negative surface charge to the abrasive particles and enhancing the stability of the slurry composition.

According to another aspect of the invention, an aqueous slurry composition for polishing/planarization of a metal film is provided. The composition includes silicon dioxide abrasive particles wherein the abrasive particles are anionically modified/doped with metallate anions selected from the group consisting of aluminate, stannate, zincate and plumbate, thereby providing a high negative surface charge to the abrasive particles. The composition further includes a corrosion inhibitor; a chelating agent able to form water-soluble complexes with ions of a polished metal; and an oxidizer, wherein the aqueous slurry composition is stable.

### BRIEF DESCRIPTION OF THE FIGURES

The invention will be better understood by reference to the FIG. 1 which illustrates the Zeta potential of colloidal silica particles (modified and unmodified), versus slurry pH.

FIG. 2, illustrates the Zeta potential of colloidal silica particles (modified and unmodified) as a function of particle size in an acidic environment.

### DETAILED DESCRIPTION OF THE INVENTION

The manufacturing of hard disks, fiber optic components and IC devices requires numerous complicated steps. In particular, IC devices require the formation of various features onto the substrate. The present invention relates to a novel slurry composition for all these applications, but is particularly useful in the chemical polishing/planarization (CMP) of substrates and metal layers, such as copper and copper alloys on semiconductor devices.

Dual damascene copper patterning has been of particular interest in multilevel interconnect formation. The present invention provides an aqueous slurry composition having modified or doped abrasive colloidal silica particles therein. This composition has been found to have particular applicability in the CMP of copper due to the stability of this acidic slurry composition, and the high removal rates of copper.

The abrasive is silicon dioxide particles modified/doped with metallate anions. The anionic surface modification results in increase of negative surface charge, which in turn provides increased stability of the silica particles in an acidic medium.

The term “anionic modification” as utilized herein refers to silica particles where metallate ions (i.e., M(OH)₄⁻) are incorporated in the particle surface and/or in the volume thereof, replacing Si(OH)₄ sites and creating a permanent negative charge. The modifying metallate may include anions of amphoteric metals which are able to form mixed insoluble silicates such as aluminate, stannate, zincate and plumbate.

Silica sols anionically modified with aluminate ions are of particular interest, and can be employed in the present invention due to their increased stability at acidic pH, as compared to unmodified ones.

As described in Iler “The Chemistry of Silica”, and incorporate herein by reference in its entirety, the process can be represented by the following reaction:

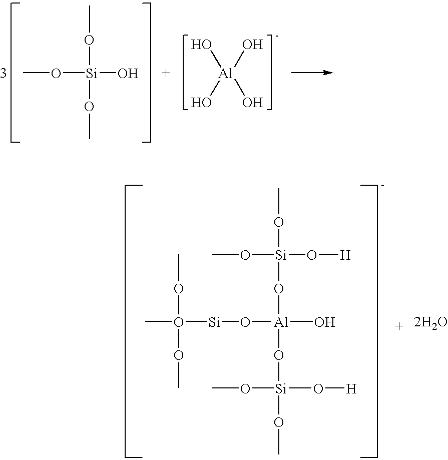

Without being bound by any particular theory, it is believed that the mechanism of anionic modification/doping of silica particles is as explained herein. Since the aluminate ion Al(OH)₄⁻ is geometrically similar to Si(OH)₄ it can be incorporated into the silicon dioxide, substituting the Si(OH)₄ sites therein and creating a negative charge. The exchange mechanism is similar to the phenomenon known as metal oxide n-type doping (i.e., isomorphic substitution of metal ions in regular positions of a crystalline lattice with lower valency cations) creating localized defects (i.e., negatively charged sites).

In the case of crystalline materials this process of isomorphic doping usually takes place in the volume of crystalline grains. Colloidal silica being a noncrystalline material, and the process of doping/modification commencing on the surface of a particle results in an overall increase of the surface negative charge. Depending on the conditions of the modification process (such as temperature, concentration of the metallate dopant, etc.), the thickness of the anionically modified layer may vary significantly.

The aluminate-modified silica employed in the present invention, can be colloidal silica or fumed silica. Colloidal silica particles are preferable due to their spherical morphology and ability to form nonagglomerated monoparticles under appropriate conditions. The slurries incorporating these particles yield a reduced number of defects and a lower surface roughness of the polished film, as opposed to irregularly shaped fumed silica particles. Colloidal silica particles may be prepared by methods known in the art such as ion-exchange of silicic acid salt, or by sol-gel technique (e.g., hydrolysis or condensation of a metal alkoxide, or peptization of precipitated hydrated silicon oxide, etc.).

The average particle size of the silica is about 10-200 nm, preferably about 20-140 nm, and most preferably about 40-100 nm. It will be understood by those skilled in the art that the term “particle size” as utilized herein, refers to the average diameter of particles as measured by standard particle sizing instruments and methods, such as dynamic light scattering techniques, laser diffusion diffraction techniques, ultracentrifuge analysis techniques, etc. In the event, the average particle size is less than 10 nm it is not possible to obtain a slurry composition with adequately high removal rate and planarization efficiency. On the other hand, when the particle size is larger than 200 nm, the slurry composition will increase the number of defects and surface roughness obtained on the polished metal film.

The content of silica particles in the aqueous slurry of the present invention is in a range of about 0.01-50 weight percent, preferably 0.1-30 weight percent depending on the type of material to be polished. As utilized herein, the term “weight percent” refers to the percentage by weight of the indicated component in relation to the total weight of the slurry. In a slurry suitable for copper CMP, the preferable content of silicon dioxide particles ranges from about 0.3-3.0 weight percent. If the silicon dioxide content is less than about 0.3 weight percent, the removal rate of copper film is not sufficient. On the other hand, the upper limit of silicon dioxide content has been dictated by the current trend of using low-abrasive slurries for copper removal to reduce the number of defects on the polished film surface. The preferable upper limit of about 3.0 weight percent has been established based on the removal rates; further increases in silicon dioxide content has been observed not to be particularly beneficial.

The inherent drawback with colloidal silica based slurries is their reduced removal rate, as compared with fumed SiO₂ and Al₂O₃ containing slurries. The present slurry composition overcomes this disadvantage by utilizing aggressive chemistries, particularly in the acidic range. The slurries preferably have a pH below 5.0, more preferably below 4.0, and most preferably below 3.5. It was found that the removal rate of copper had increased two fold and five fold when the pH of the slurry was decreased from 5.0 to 4.0 and 3.2, respectively.

Stability of the colloidal silica particles, particularly for anionically modified ones with aluminate, was employed in the slurries of the present invention, and was quantified by measuring the Zeta potential. Those skilled in the art will recognize the Zeta potential as a measure of the electrostatic interaction between colloidal particles to predict the stability of the colloidal dispersion. The charge interactions between particles play a vital role in electrostatic stabilization of colloidal dispersions. In particular, it has been found that in a stable colloidal system, the repulsive interactions overcome the Van de Waals attraction forces. The higher is absolute magnitude of the Zeta potential, the more stable the slurry is. If the Zeta potential is too small (i.e., less than 15-20 mV in absolute magnitude), the particles will begin to agglomerate in time. This agglomerization and growth of oversized particles, leads to a deterioration of the slurry's performance in a CMP process, and in turn leads to a shortened slurry shelf life and increased defects on the film polished, upon use.

An important feature of the invention is to provide a silica based acidic slurry (i.e., having a pH of 6.0 or lower, and preferably ranging from about 2.5-3.5), wherein the silica particles have a Zeta potential more negative than −15 mV, preferably, more negative than −20 mV, and most preferably −25 mV.

This goal can be achieved only when anionically modified/doped colloidal silica particles were employed in the slurries.

It was found that when unmodified colloidal silica particles were utilized in the slurries, the magnitude of Zeta potential of the slurry drastically dropped with decreasing slurry pH: from −35 mV at pH=5.0 to −12 mV at pH=3.5 and to −5 mV at pH=3.2. The data indicates that a decrease in the slurry pH leads to reducing surface charge and hence destabilization of unmodified colloidal SiO₂. Likewise, an increase in ionic strength of the slurry associated with increasing electrolyte content causes the destabilization. The observed destabilization renders the unmodified particles incompatible with acidic slurry chemistries, in particular with acidic Copper CMP chemistries.

The anoianically modified/doped colloidal particles in the acidic copper slurry of the present invention render stability to the slurry, and high removal rates are achieved, while preserving all the morphological advantages of colloidal silica abrasive particles. Employing anionically modified silica particles with increased permanent negative charge eliminates inherent limitations of the silica colloids (i.e., their instability in polishing slurries with a pH of 4.0 or lower).

High removal rates of the slurries of the present invention which contain the anionically modified silica particles are not accompanied by an accelerated static etch. Static etch rate (SER) was maintained low by optimizing the amount of corrosion inhibitor. Benzatriazole (BTA) can be utilized as a corrosion inhibitor/film forming agent to avoid unwanted isotropic copper etching. While BTA is an established corrosion inhibitor for copper, other corrosions inhibitors such as imidazole, triazole, benzimidazole, derivatives and mixtures thereof, are suitable alternatives.

The amount of BTA in the slurries of the present invention range from about 0.015-0.15 weight percent, preferably about 0.030-0.1 weight percent, and most preferably about 0.045-0.085 weight percent. The optimum BTA content is determined based on the criteria of obtaining low isomorphic etch rate of copper film as compared to the amount of copper removed from protruding sections due to surface planarization (i.e., high RR:SER ratio, preferably higher than 50:1, more preferably higher than 100:1). It is preferable to use minimum amount of BTA, sufficient to meet the above requirement, because the excess of BTA was found to result in slowing copper polish removal.

Another component of the slurry composition is the chelating/complexing agent. The chelating agent can be selected, for example, from among carboxylic acids (such as acetic, citric, oxalic, succinic, lactic, tartaric, etc.) and their salts, as well as aminoacids (such as alanine, glutamine, serine, histidine, etc.), amidosulfuric acids, their derivatives and salts. In a preferred embodiment, the chelating agent utilized is glycine. The content thereof in the slurry ranges from 0.05-5.0 weight percent, preferably about 0.1-3.0 weight percent, and most preferably about 0.5-1.5 weight percent. The ranges selected are dependent on the requirement to reach a favorable balance between removal rate and static etch rate: the chelating agent's concentration must be high enough to provide efficient complexing action; however, an increase in chelating agent concentration also results in the increase of copper static etch.

Another component generally added to the slurry composition is the oxidizer. Although hydrogen peroxide is preferably utilized, other oxidizers can be selected, for example, from among inorganic peroxy compounds and their salts, organic peroxides, compounds containing an element in the highest oxidation state, and combinations thereof. In a preferred embodiment, hydrogen peroxide is added to the slurry shortly before employment of the slurry in the CMP process. The slurry of the present invention when mixed with hydrogen peroxide has a pot life of at least seventy-two hours, often more than hundred hours. The amount of hydrogen peroxide added to the slurry is determined by the requirement necessary to maintain high removal rates of copper on the one hand and a low static etch on the other. Preferably the amount of hydrogen peroxide added to the slurry composition ranges from about 0.1-10 volume percent, preferably about 0.5-5.0 volume percent, and most preferably about 0.75-3.0 volume percent.

In the event that the pH of the slurry requires adjustment, acids may be added to the composition. Some of the strong acids that may be selected for this purpose include sulfuric acid, nitric acid, hydrochloric acid and the like. Preferably, the acid is orthophosporic acid (H₃PO₄). On the other hand, if an alkali is needed to adjust the pH to a more basic state, alkali metal hydroxides such as potassium hydroxide, sodium hydroxide and ammonia may be utilized. Further, organic bases such as trethanolamine, tetramethylammonium hydroxide (TMAH) and the like may be employed as well.

The slurry may also contain additional components such as biocides, pH buffers, additives to control foaming, viscosity modifiers, etc.

Biocides, for example, prevent growth of microorganisms such as bacteria, and fungus. Microorganism growth in known as one of the major contamination sources and of great concern in IC manufacturing. Once on the device, bacteria acts as particulate contamination. Certain slurry components such as aminoacids (e.g., glycine) are particularly susceptible to microbial growth. To prevent the microorganism growth, in an embodiment of the present invention, a biocide in an amount of 50-1000 ppm can be introduced in the slurry composition. Examples of useful biocides include Dow Chemical Company's BIOBAN™ and Troy Corporation's MERGAL K12N™.

Drastic suppression of microbial growth is an additional benefit of reducing pH of the slurries, as the mold growth is pH dependent. It generally, starts at a pH of 4.0 and the growth accelerates at a higher pH. It was found that in a slurry composition having a pH of 4.0 it takes approximately 4 days for 300 cfu/ml of mold to grow. In a month the mold multiplied ten-fold. On the other hand, when the slurry pH is 3.2 no microbial growth was detected after one month, and very little growth (less than 16 cfu/ml) was detected after two months. Therefore, the required amount of biocide is significantly lower for slurries having a pH lower than 4.0.

The aqueous slurry compositions of the present invention will be further described in detail with reference to the following examples, which are, however, not to be construed as limiting the invention.

### EXAMPLES

The following slurry compositions of Examples 1-15 were prepared and utilized to polish 8′ blanket copper wafers (15K Angstrom Electroplated Cu film, annealed) or 2′ coupons cut from these wafers. Polishing tests were carried out on a Strassbaugh 6EC CMP polisher at 2.0 psi downforce, 80 rpm platen rotation speed, 60 rpm wafer carrier rotation speed, 200 ml/min slurry flow rate), as well as on a bench-top polisher, Model UMT-2, Center for Tribology, Inc. The polishing parameters for the bench-top polisher (3.0 psi downforce, 140 rpm platen speed, 135 rpm carrier speed) were chosen to match the removal rate obtained on the Strassbaugh 6EC CMP polisher. IC1000™ stacked pad with Suba IV™ subpad by Rodel Co. Inc., was utilized on both polishing tools. The pad had been conditioned in-situ.

The polishing rate (Å/min.) was calculated as the initial thickness of each film having subtracted therefrom after-polishing film thickness and divided by polishing time. The average from at least five polishing tests was used to calculate removal rate. Copper film thickness data had been obtained by RS 75 sheet resistance measuring tool, KLA Tencor, Inc.; 81 point diameter scan at 5 mm edge exclusion was used for metrology.

Zeta potential measurements (i.e., one-point data at fixed pH as well as Zeta-pH curves) for colloidal particles in the slurries were performed on ZetaSizer Nano-Z, Malvern Instruments Co. Standard 1N, 0.5N and 0.1N solutions of HNO₃ and KOH were used for pH titration.

Slurry stability/shelf life was in addition tested by measuring Large Particle Count (LPC)—number of oversized colloidal particles (i.e., larger than 1.5 micron) which grow with time. The less LPC changes with slurry storage time, the more stable are the colloidal silicon dioxide particles in the slurry. An AccuSizer Model 780 instrument from Particle Sizing Systems, Inc., was utilized to measure LPC. The results were calculates as an average from 5 tests per each sample.

### Comparative Example 1

In example 1, corresponding slurry A, has been prepared by adding 1.74 g BTA (from Sigma-Aldrich) and 32 g glycine (Sigma-Aldrich) into 3,120 g deionized H₂O. A diluted solution of 7 weight percent H₃PO₄ was employed to adjust the pH to about 4.0. Thereafter, 106.6 g of 30 weight percent non-modified colloidal silica (as 30 weight percent water dispersion) having a particle size (Zₐᵥ) of 85 nm was added to the solution while mixing; the silica content in the slurry was equal to 1.0 w.%. The slurry was then mixed for about 0.5 hours, and 20 ml of H₂O₂ (as 34 weight percent water solution) is added so that the content of H₂O₂ was 2 volume percent. The slurry was then utilized to perform the above-described polishing tests. This so-called slurry A was found to remove the copper film at a rate of 3,400 Å/min. This demonstrates that the slurry having a pH of 4.0 and which contains colloidal silica abrasive particles does not provide copper film removal sufficient to ensure high wafer throughput.

### Comparative Example 2-7

In examples 2-7, corresponding slurries B-G, were prepared in the same manner as the slurry of Example 1 (i.e., slurry A), except that the slurries were adjusted to different pH. The slurries were tested for removal rate and the Zeta potential measurement were performed. The results are tabulated in Table 1, below.

TABLE 1
Zeta potential and Removal Rate for Copper CMP Slurries
as a function of pH

| | | | Removal | Zeta |
|---|---|---|---|---|
| | | | Rate | potential |
| | Slurry | pH | Å/min. | mV |
| Example 2 | B | 3.0 | 10,500 | −5 |
| Example 3 | C | 3.2 | 6,700 | −8 |
| Example 4 | D | 3.5 | 4,900 | −11 |
| Example 5 | E | 4.2 | 3,100 | −19 |
| Example 6 | F | 4.5 | 2,100 | −22 |
| Example 7 | G | 5.0 | 1,500 | −25 |

As seen from this data, there is a strong dependency of blanket copper film removal rate relative to pH. Removal rate for Example 3 (i.e., Slurry C) having a pH of 3.2 is about two times higher than that of Example 1 (i.e., Slurry A) which has a pH of 4.0. However, these slurries containing non-modified silica abrasive particles, were found to have a dramatic decrease in negative surface charge (i.e., Zeta potential), indicating that the particles are unstable under these conditions. As a result, the non-modified silica particles cannot be used in a slurry having a pH lower than 4.0.

### Example 8

In Example 8, corresponding slurry H, has been prepared by adding 1.74 g BTA (from Sigma-Aldrich) and 32 g glycine (Sigma-Aldrich) into 3,120 g deionized H₂O. A diluted solution of 7 weight percent H₃PO₄ was employed to adjust the pH to about 3.2. Thereafter, 106.6 g of 30 weight percent water dispersion of aluminate-modified colloidal silica with particle size Zₐᵥ equal to 77 nm was added to the solution while mixing. The resulting content of colloidal silicon dioxide was 1 weight percent. The slurry was then mixed for 0.5 hours.

Therefore, the only difference between Slurry C (i.e. Comparative Example 3) and the one of Slurry H is the type of colloidal silica particles employed. The Zeta potential versus the pH was measured for both slurries and presented in FIG. 1.

As shown from this data, for unmodified particles negative surface charge rapidly decreases at pH below 4.0, indicating a destabilization of the slurry. Aluminate-modified particles, on the other hand, preserve a high negative charge (above −20 mV) in the entire pH range. Thus, colloidal abrasive particles will remain stable in slurries having a pH as low as 2.5.

Slurries H and C, were then mixed with 20 ml of H₂O₂ (as 34 weight percent water solution), so that the final content of H₂O₂ was equal to 2 volume percent and used to perform the above-described polishing tests. Both slurries demonstrated similar removal rates (for Slurry A RR equal to 6,200 Å/min. and for Slurry H RR equal to 6,600 Å/min).

### Example 9

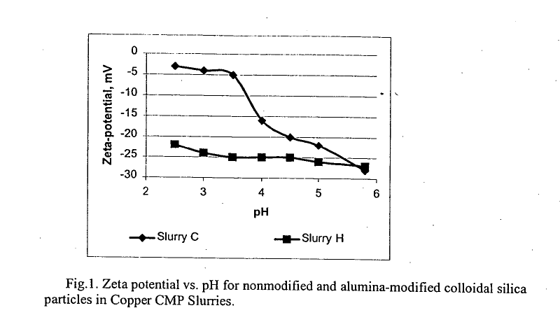

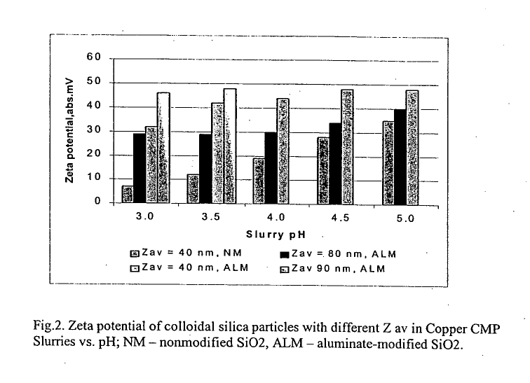

To further explore the impact of aluminate modification on colloidal silica stability in acidic slurries, several compositions with a varying particle size (i.e., Zₐᵥ ranging for 40 to 90 nm) were prepared. These slurries were compared side-by-side with a slurry having the same exact composition, but for the fact that the colloidal silica is non-modified. The data obtained is depicted in FIG. 2.

As the data indicates, the slurries containing the modified aluminate silica particles of different particle sizes have been found to be more stable (i.e., measured by Zeta potential) in an acidic environment (i.e., pH of 4.0 or less), as compared to the non-modified composition.

### Examples 10-15

Slurries with various amounts of aluminate-modified silicon dioxide abrasive particles were prepared by adding 1.74 g BTA and 32 g glycine into 3,120 g deionized H₂O. The pH of the slurries were adjusted to pH=3.2 by adding 7 weight percent of H₃PO₄. Thereafter, 30 weight percent water dispersion of aluminate-modified colloidal silica (having particle size Z_{az} of 48 nm) was added under permanent mixing, so that the resulting content of SiO₂ was equal to 0, 0.5, 1.0, 2.0, 3.0 and 5.0 weight percent in Examples 10-15 (corresponding to Slurries I-N, respectively and listed in Table 2, below).

Each of the slurries were mixed for 0.5 hours. Thereafter, the slurries were mixed with 20 ml of H₂O₂ (as 34 weight percent water solution), so that the final content of H₂O₂ was equal to 2 volume percent. The slurries were then used to perform the above-described polishing test. The removal rate of blanket copper film for each of these slurries is reported in Table 2.

TABLE 2
Removal Rate of Copper as a Function of Aluminate-
Modified Silica Content

| | | SiO₂ (weight | Removal Rate |
|---|---|---|---|
| | Slurry | percent) | (Å/min) |
| Example 10 | I | 0 | 3,000 |
| Example 11 | J | 0.3 | 4,800 |
| Example 12 | K | 0.5 | 5,450 |
| Example 13 | L | 1.0 | 6,250 |
| Example 14 | M | 3.0 | 6,400 |
| Example 15 | N | 5.0 | 6,450 |

As demonstrated by the data, the most preferable Sio₂ content is in the range of about 0.3 to 3.0 weight percent. If the silica content is less than 0.3 weight percent, the removal rate of copper film is not high enough. On the other hand, if the silica content is above 3.0 weight percent, it is not particularly beneficial for the removal rate.

### Example 16

Slurry C (Example 2) and Slurry H (Example 8) have been stored for 90 days at room temperature. The only difference in between these slurries is that Slurry C is of nonmodified SiO₂ particles, while in Slurry H the SiO₂ particles are aluminate modified. During the testing period the slurries were tested to determine the growth of oversized particles (i.e., particles larger than 1.5 microns. The data obtained is listed in Table 3, below.

TABLE 3

| | | 14 days | 30 days | 60 days | 90 days |
|---|---|---|---|---|---|
| | As prepared | later | later | later | later |
| Slurry C | 2,200 | 5,1250 | 11,500 | 42,700 | precipitate |
| Slurry H | 1,400 | 1,500 | 1,750 | 2,150 | 3,900 |

As indicated by the data obtained, Slurry C has shown a rapid growth in oversized particles, resulting in complete deterioration. This deterioration is due to the coagulation and precipitation of the colloidal particle. By comparison, Slurry H demonstrated very slow growth of oversized particles over the entire testing period. Clearly, this data evidences the use of aluminate-modified abrasive particles imparts increased stability of CMP slurries.

While the invention has been described in detail with reference to specific embodiments thereof, it will become apparent to one skilled in the art that various changes and modifications can be make, and equivalents employed, without departing from the scope of the appended claims.

What is claimed is:

1. An aqueous slurry composition for polishing/planarization of a substrate, comprising silicon dioxide abrasive particles wherein said abrasive particles are anionically modified/doped with metallate anions selected from the group consisting of aluminate, stannate, zincate and plumbate, thereby providing a high negative surface charge to said abrasive particles and enhancing the stability of said slurry composition.

2. The aqueous slurry composition of claim 1, wherein said metallate anions are aluminate anions (Al(OH)₄⁻).

3. The aqueous slurry composition of claim 1, wherein said silicon dioxide abrasive particles are colloidal.

4. The aqueous slurry composition of claim 1, wherein the modified/doped silica abrasive particles have a Zeta potential more negative than −10 mV.

5. The stable aqueous slurry composition of claim 1, wherein said slurry is acidic and said silicon dioxide abrasive particles are modified/doped with aluminate anions and their Zeta potential is more negative than −10 mV.

6. The stable aqueous slurry composition of claim 1, wherein the content of said silicon dioxide abrasive particles is in the range of about 0.01 to 50 weight percent.

7. The stable aqueous slurry composition of claim 1, wherein said slurry composition is employed in the chemical mechanical polishing/planarization of copper interconnect dual damascene structures.

8. The stable aqueous slurry composition of claim 5, wherein said slurry composition is employed in the chemical mechanical polishing/planarization of copper interconnect dual damascene structures.

9. The stable aqueous slurry composition of claim 1, wherein the size of said silicon dioxide abrasive particles is in the range of about 10 to 200 nm.

10. An aqueous slurry composition for polishing/planarization of a metal film, comprising:
silicon dioxide abrasive particles wherein said abrasive particles are anionically modified/doped with metallate anions selected from the group consisting of aluminate, stannate, zincate and plumbate, thereby providing a high negative surface charge to said abrasive particles,
a corrosion inhibitor;
a chelating agent able to form water-soluble complexes with ions of a polished metal; and
an oxidizer, wherein said aqueous slurry composition is stable.

11. The aqueous slurry composition of claim 10, wherein said metallate anions are aluminate anions (Al(OH)₄⁻).

12. The aqueous slurry composition of claim 10, wherein the surface modified/doped silica abrasive particles have a Zeta potential more negative than −10 mV.

13. The aqueous slurry composition of claim 10, wherein said slurry is acidic and said silicon dioxide abrasive particles are modified/doped with aluminate anions and have a Zeta potential more negative than −10 mV.

14. The aqueous slurry composition of claim 13, wherein said silica abrasive particles are colloidal.

15. The aqueous slurry composition of claim 10, wherein said slurry has a pH of 6.0 or lower.

16. The aqueous slurry composition of claim 14, wherein said slurry has a pH of 6.0 or lower.

17. The aqueous slurry composition of claim 10, wherein said slurry has a pH of 4.0 or lower.

18. The aqueous slurry composition of claim 14, wherein said slurry has a pH of 4.0 or lower.

19. The aqueous slurry composition of claim 10, wherein the content of said silicon dioxide abrasive particles is in the range of about 0.01 to 50 weight percent.

20. The aqueous slurry composition of claim 10, wherein the content of said corrosion inhibitor is in the range of about 0.015 and 0.15 weight percent.

21. The aqueous slurry composition of claim 10, wherein the content of said chelating agent is in the range of about 0.05 and 5.0 weight percent.

22. The aqueous slurry composition of claim 10, wherein the content of said oxidizer is in the range of about 0.1 and 10 volume percent.

23. The aqueous slurry composition of claim 10, wherein said slurry solution is employed in the chemical mechanical polishing/planarization of copper interconnect dual damascene structures.

24. The aqueous slurry composition of claim 10, wherein said metal film is copper or a copper alloy, said corrosion inhibitor is selected from the group consisting of imidazole, triazole, benzimidazole, benzotriazole, derivatives and mixtures thereof, and said chelating agent is selected from the group consisting of aminoacids, carboxylic acids, their derivatives and salts.

25. The aqueous slurry composition of claim 24, wherein said slurry has a pH of 6.0 or lower.

26. The aqueous slurry composition of claim 24, wherein said slurry has a pH of 4.0 or lower, said silica abrasive particles are colloidal and have a Zeta potential more negative than −20 mV.

27. The aqueous slurry composition of claim 26, wherein said slurry is employed in the chemical mechanical polishing/planarization of copper interconnect dual damascene structures.

28. The aqueous slurry composition of claim 10, wherein the content of said silicon dioxide abrasive particles is in the range of about 0.03 to 5.0 weight percent.

29. The aqueous slurry composition of claim 24, wherein the content of said silicon dioxide abrasive particles is in the range of about 0.03 to 5.0 weight percent.
